(19) United States
(12) Patent Application Publication
(10) Pub. No.: US 2016/0106617 A1
(43) Pub. Date: Apr. 21, 2016

(54) Walker for Disabled Persons

(71) Applicant: Richard N. SARNS, Ann Arbor, MI (US)

(72) Inventors: David WOBITH, Saugatuck, MI (US); Philip DAVIS, Royal Oak, MI (US); Kyle HAPPY, Newport, MI (US); Jonah SHAPIRO, Milwaukee, WI (US); Corwin Stout, Plymouth, MI (US)

(73) Assignee: Richard N Sarns, Ann Arbor, MI (US)

(21) Appl. No.: 14/649,635

(22) PCT Filed: Dec. 6, 2013
(86) PCT No.: PCT/US13/73599

§ 371 Date: Jun. 4, 2015

Related U.S. Application Data
(60) Provisional application No. 61/734,195, filed on Dec. 6, 2012.

(51) Int. Cl. A61H 3/04; A61G 5/10; A61G 5/08; A61G 5/14

(52) U.S. Cl. CPC A61H 3/04; A61G 5/14; A61G 5/1002; A61G 5/08; A61G 5/1056; A61H 2201/0161; A61H 2201/1633; A61H 2201/1676; A61G 2005/0841

(57) ABSTRACT

A walker for enabling ambulatory movement of disabled individuals. A frame assembly has front and rear legs with wheels. The legs are pivotably connected via a hinge and a support linkage. The support linkage permits folding together of the legs in a storage condition of the walker, and permits the legs to be being angularly separated for a use condition. A seat assembly includes a seat bottom foldable between up and down positions. A seat back and a toilet seat are affixed to the frame with the seat bottom being pivotable. The seat bottom overlays the toilet seat when in the down position and exposes the toilet seat for use when in the up position. The frame assembly enables the seat assembly and the toilet seat to be in a generally parallel orientation when the walker is in the folded-up storage condition.

### CROSS-REFERENCE TO RELATED APPLICATION

This application claims priority to U.S. Provisional Patent Application No. 61/734,195, filed on Dec. 6, 2012.

### FIELD OF THE INVENTION

This invention relates to a walker for use by disabled persons and particularly to such a device that, in addition to aiding mobility generally has accommodations for enabling a disabled person to conveniently use restroom facilities.

### BACKGROUND OF THE INVENTION

Numerous individuals need help in mobility, for example aged individuals and those with physical or other disabilities sometimes need help in their mobility. A certain class of these individuals are able to move without external assistance but require an appliance device. Walker type devices are in widespread use and enable the user to support some of their weight as they walk. These devices generally fall into two categories. One type is a simple frame with rubber pads on bottom pegs that enable a user to move along by shuffling the device as they walk. Another type uses caster type rolling wheels that enable the device to glide along as the user guides it. This invention is related to the latter type.

One problem encountered by physically challenged individuals using walkers is in using restroom facilities. It is sometimes difficult for these individuals to move from a walker to sit on a regular commode toilet seat. Accordingly there is a need to better enable individual using walkers to use these facilities with minimal difficulty, and without external assistance.

This invention is related to a walker which provides excellent ease of use in facilitating movement and has provisions for enhancing the ability for the user to use restroom facilities. Furthermore, the device according with this invention is readily stored and provides a seating surface for the user.

### BRIEF DESCRIPTION OF THE DRAWINGS

FIGS. 1 through 5 are pictorial views of the walker in accordance with this invention, shown with the seating bottom panel in its normal downward position;

FIGS. 6 and 7 are pictorial views of the walker shown with the seating bottom panel in a folded upward position enabling access to a toilet seat;

FIG. 8 is a pictorial view of the walker in a folded condition;

FIG. 9 is a pictorial of view of the device with the seat back in a folded down position; and

FIGS. 10 through 16 are illustrations of the device used in a restroom situation.

### DETAILED DESCRIPTION OF THE INVENTION

Each of the figures show the walker device in accordance with this invention which is generally identified by reference number 10. Walker 10 can be thought of as constituting three major subassemblies or functional groups, including seat assembly 12, frame assembly 14, and wheel assemblies 16.

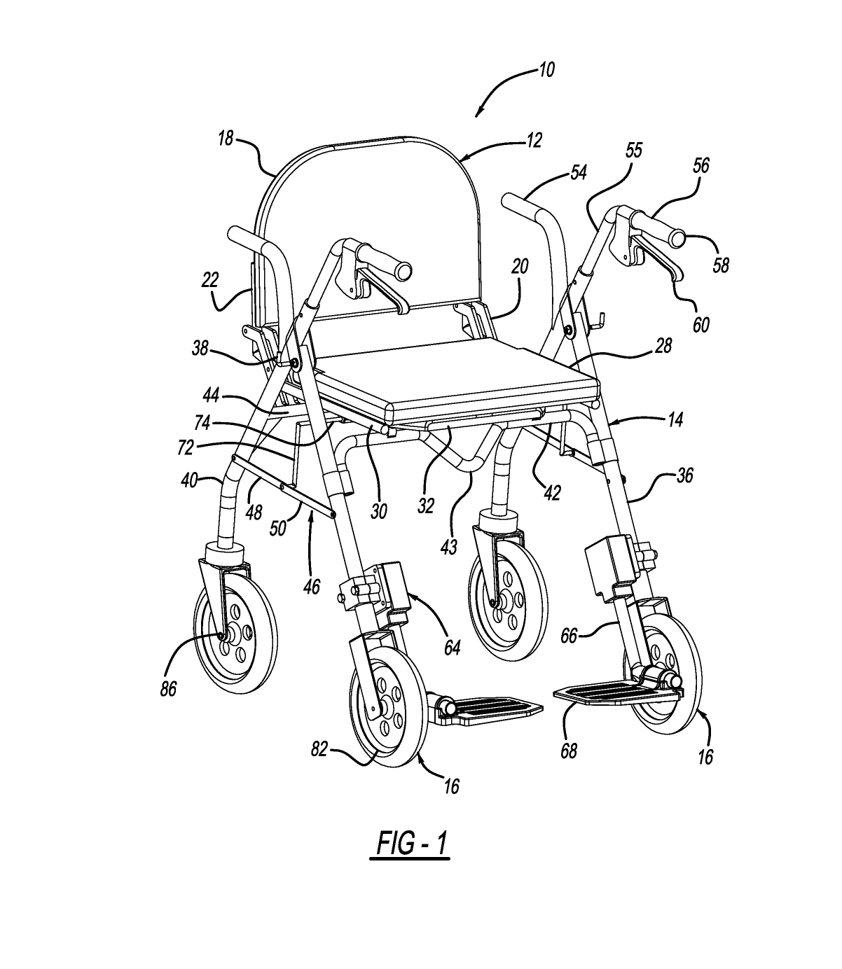

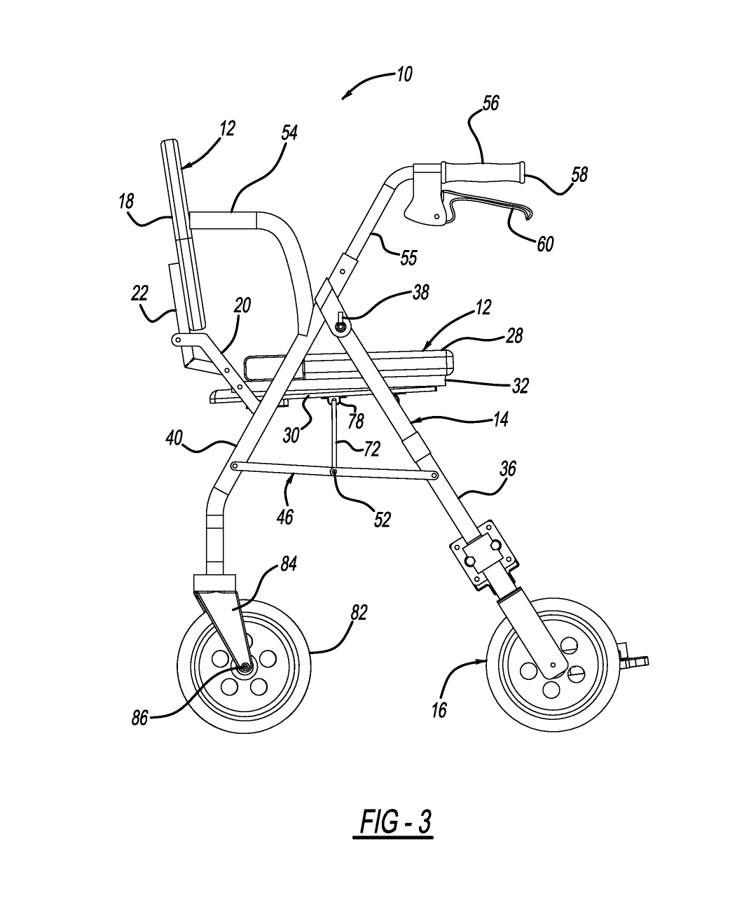

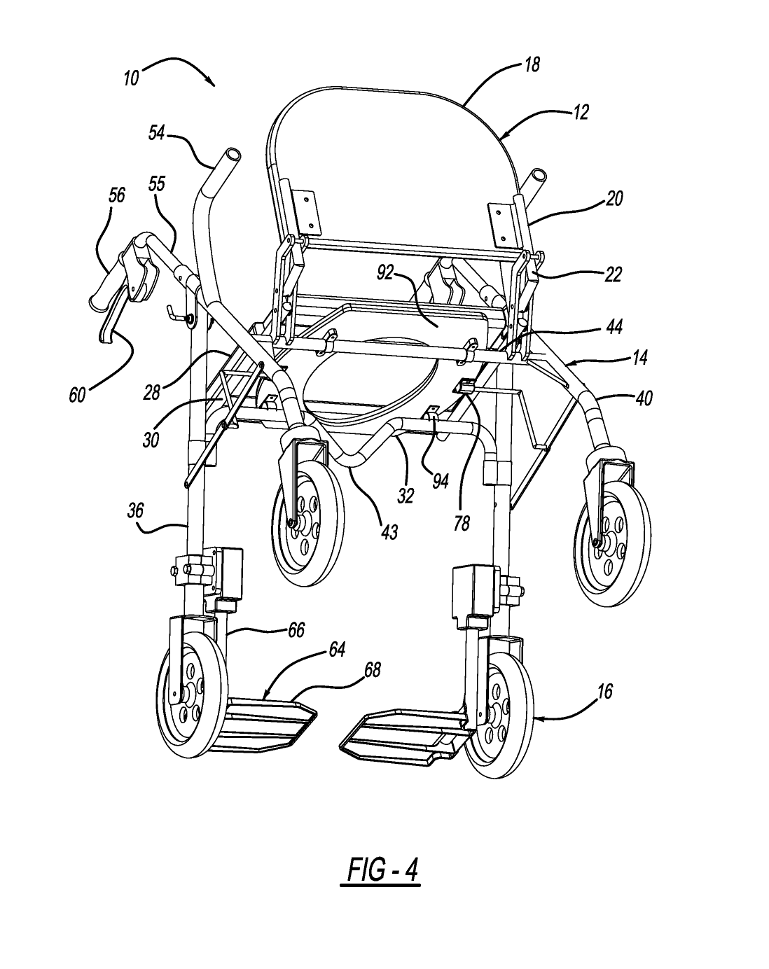

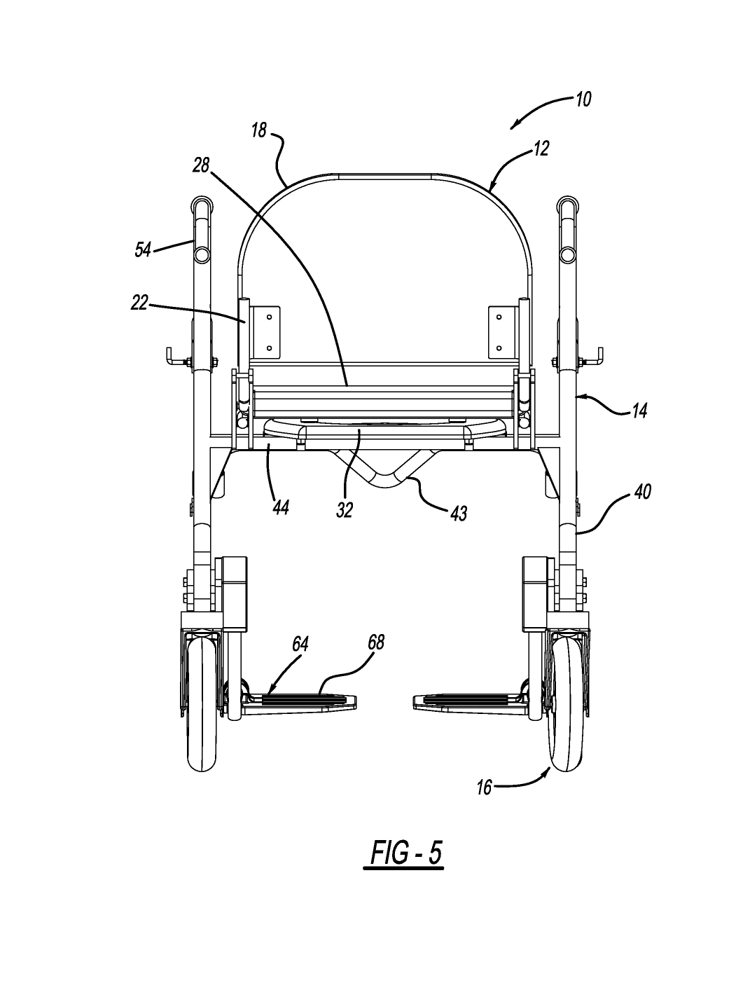

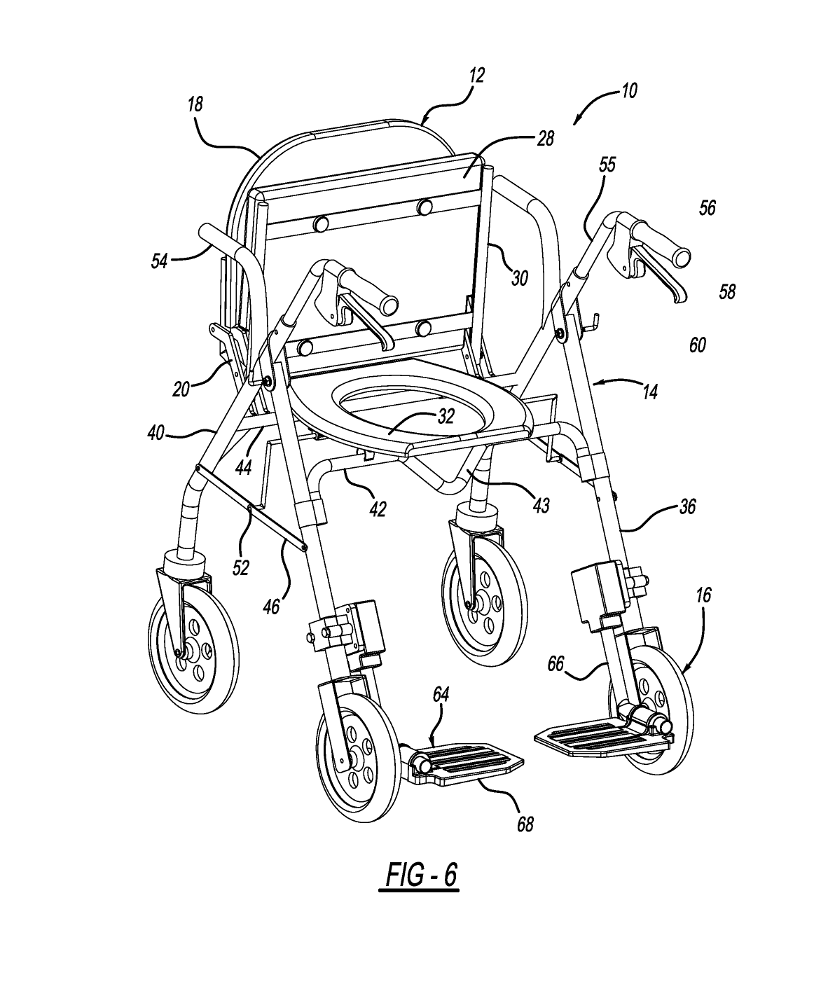

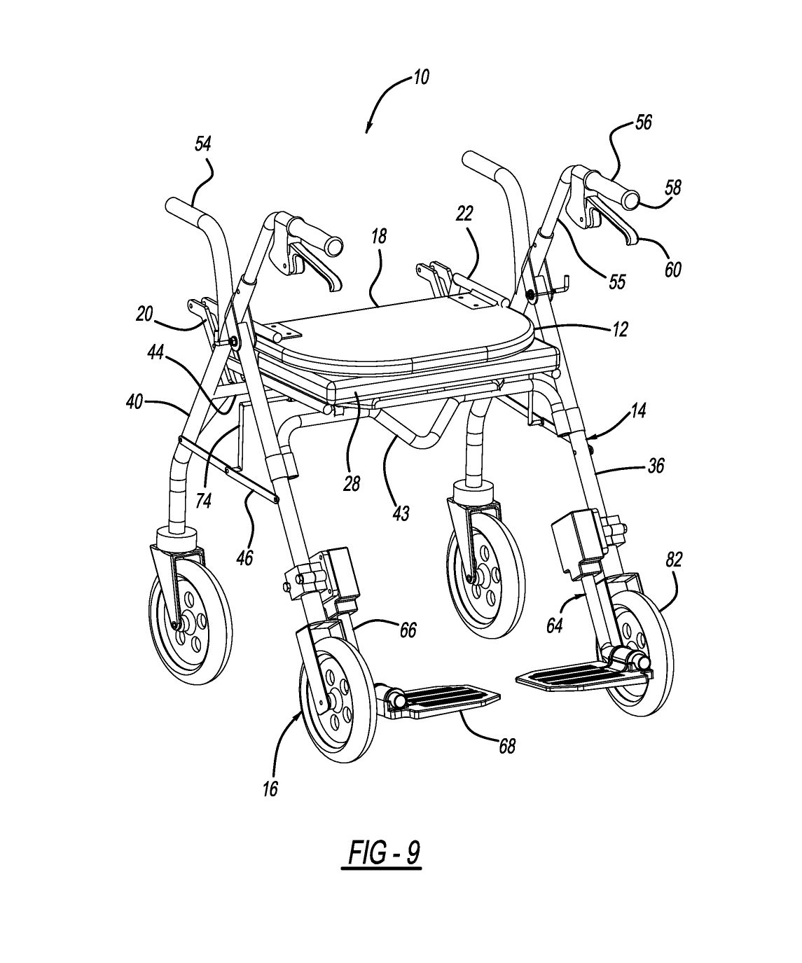

Seat assembly 12 includes seatback 18 which is hinged to frame assembly 14 by brackets 20. Conveniently, the height of seatback 18 can be adjusted through movement along adjustment posts 22. Seatback 18 can be moved from its normal upright position for example as shown in FIGS. 1 through 8, to a folded downward position as shown in FIG. 9. Seat bottom 28 is similarly foldable from a normal seating position for example as shown in FIGS. 1 through 5 to a folded up position shown in FIG. 6. Seat bottom is affixed to frame assembly 14 via brackets 30.

Seat assembly 12 further incorporates toilet seat 32 which, in a normal use condition of walker 10, is covered and obscured by seat bottom 28. The use and functioning of the various components will be described later in this specification.

Frame assembly 14 includes rear legs 36 which, at their tops, are mounted via a hinge 38 to front legs 40. A wheel assembly 16 is mounted to the bottom end of each of rear legs 36 and front legs 40. For stability reasons, one set of wheel assemblies 16 associated with the front and rear legs 40 and 36 could be mounted for free swiveling or in a caster-like manner, whereas the other set would be fixed so as not to rotate (about a vertical axis)for improving the stability of movement of walker 10. It should be noted that reference to “front” and “rear” for the legs 36 and 40 is from the frame of reference of the device being used as a walker (described more below). When the walker 10 is used in a restroom, one would normally think of these references being reversed.

Cross bars 42 and 44 extend “front” and “rear” laterally across the device and are affixed respectively to rear legs 36 and front legs 40. Cross bars 42 and 44 provides support for seat bottom 28 and toilet seats 32. A foldable support link 46 is in the form of two separate links 48 and 50 connected together at pivot pin 52. The opposite ends of links 48 and 50 are connected by pins to their respective legs for pivoting movement. Crossbar 42 features a center downwardly projecting V-shaped bend 43 at its center.

Link bar 72 is affixed to support links at pivot 52 and include a laterally extending bar section 74 which is captured by pivot mounts 78 affixed to the bottom surface of toilet seat 32.

Grab handles 54 join front legs 40 and provide a convenient supporting feature for the user when maneuvering using the device. Preferably, post 55 will telescope into the tube forming front legs 40 and would have means for vertical adjustment to suit a user's needs. Primary grab handles 56 form upward extensions of front legs 40 and conveniently provide cushioned grips 58 and brake release handles 60. Brake release handles 60 are coupled with a braking device (not shown) provided to lock at least one of the sets of wheel assemblies 16 when they are not squeezed toward grips 58. This provides for stability of the device when it is not intentionally being moved by the user.

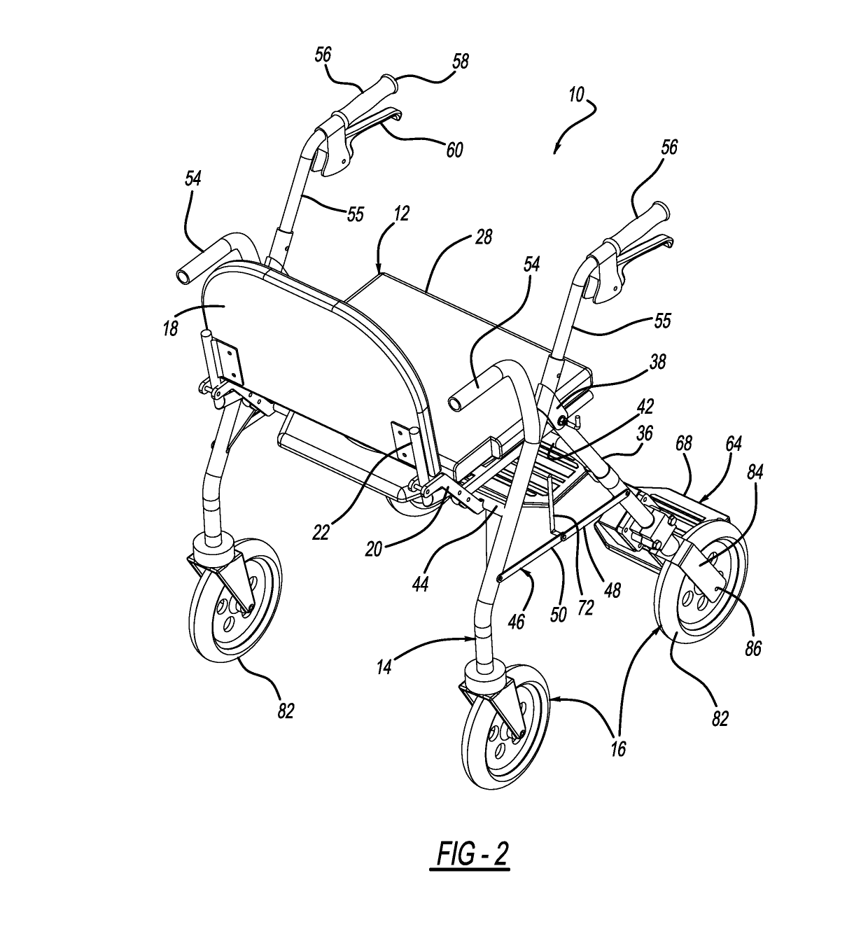

Foot support assemblies 64 are clamped to rear legs 36 and include a downwardly extending bar 66 which provides adjustability of the downward position of foot platforms 68 which can be conveniently folded from their downward normal position shown in FIGS. 1 and 2 to a folded up position (not shown).

Wheel assemblies 16 include wheels 82 coupled to support forks 84 by a central axle 86 with an associated bearing assembly. As mentioned previously, one of the sets of wheel assemblies 16 are preferably fixed whereas another set associated with the front or rear legs of the device would be mounted for caster movement. Generally the front set of wheel assemblies 16 attached to front leg 40 would have caster movement whereas the rear leg set would be fixed.

FIGS. 1 through 5 illustrates walker 10 in its normal use condition. Foot platforms 68 may be pivoted to a vertical position and the device can be used by the user grasping grips 58 and brake release handles 60 enabling the device to be used in the manner of a generally conventional wheeled walker.

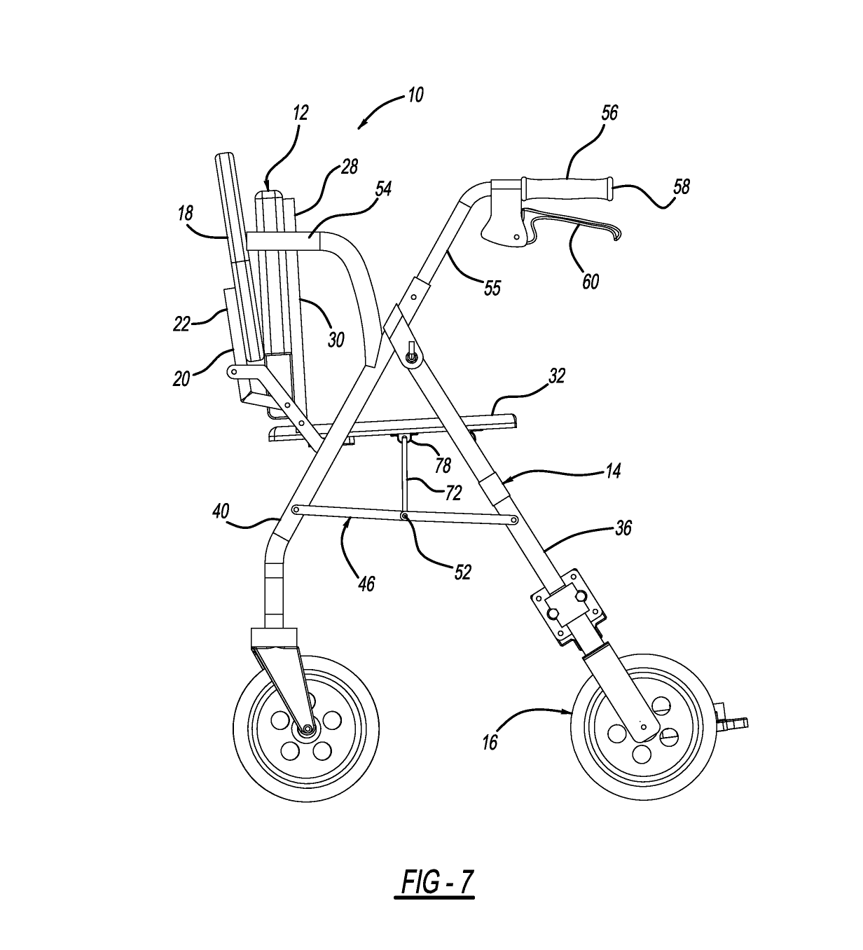

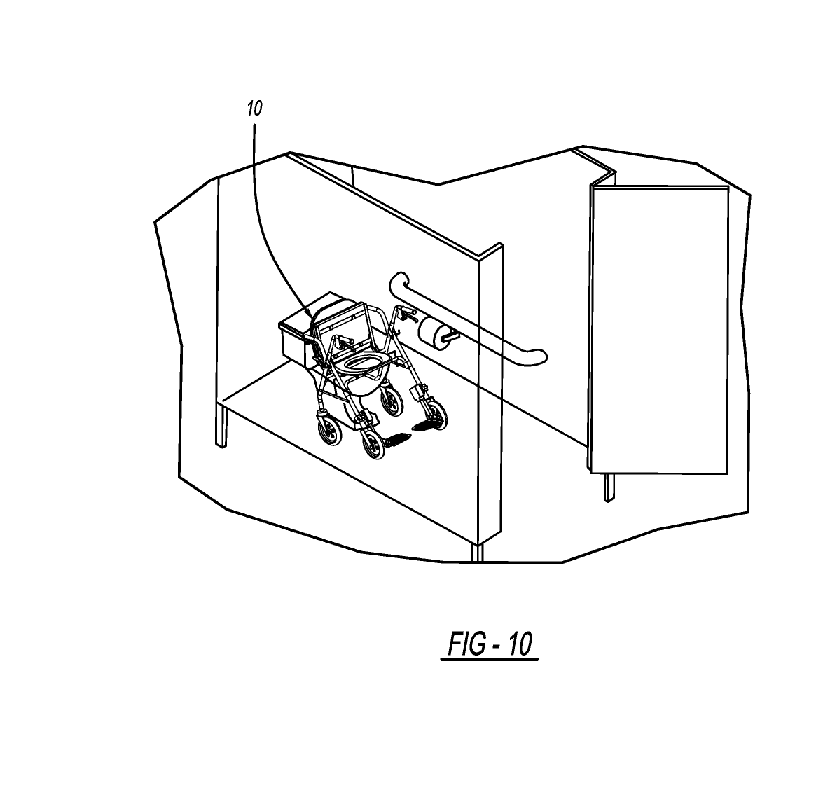

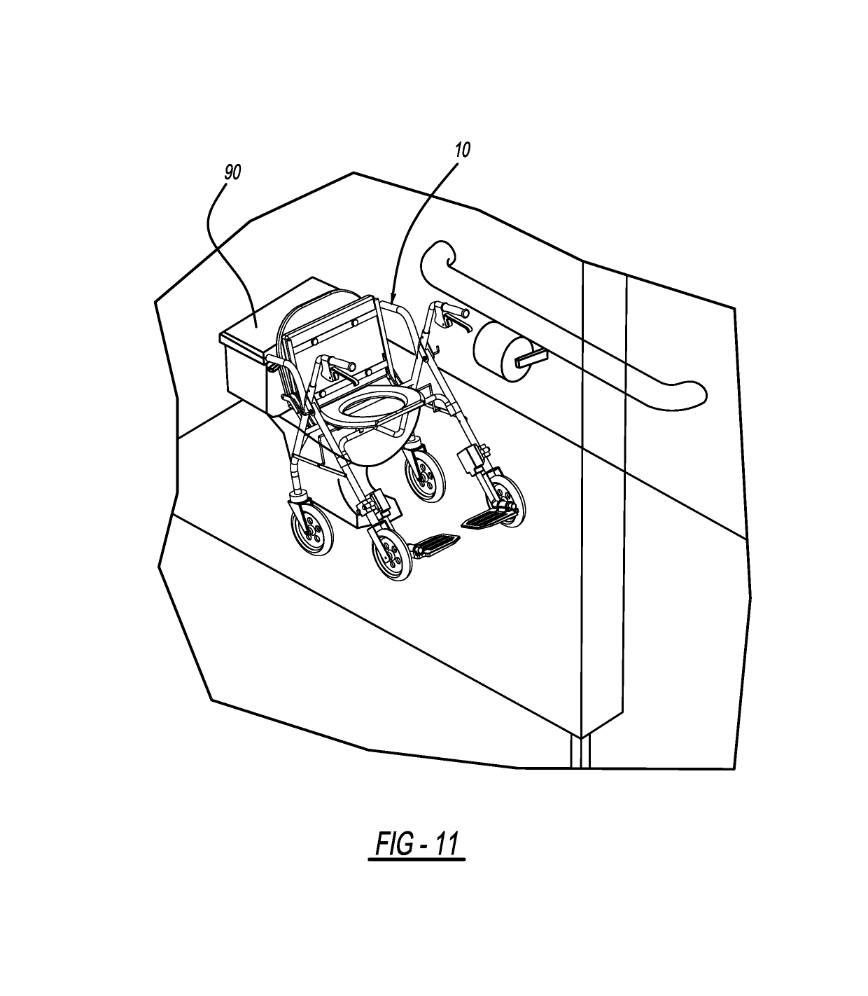

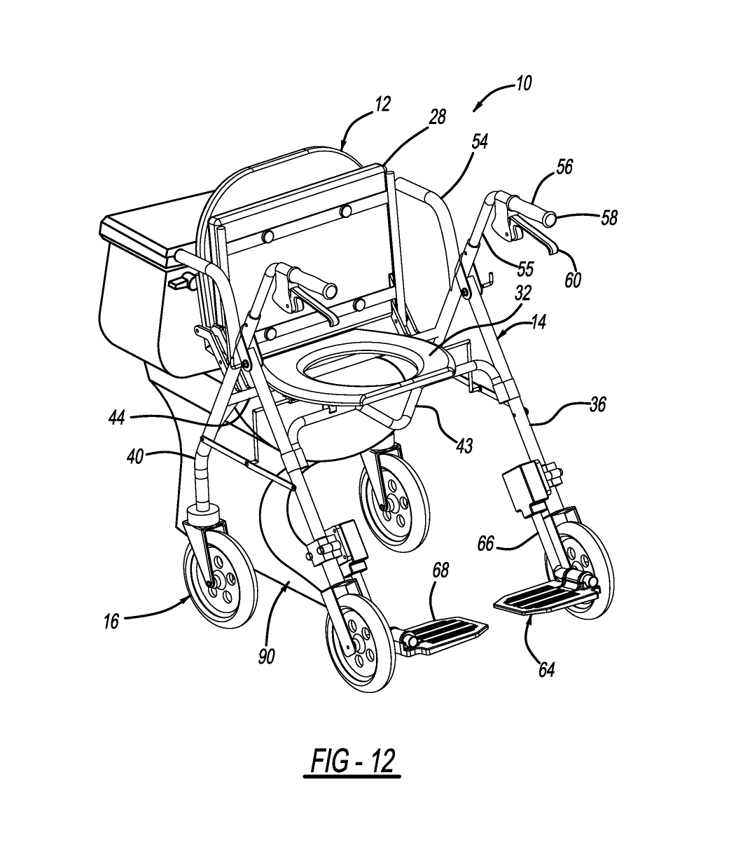

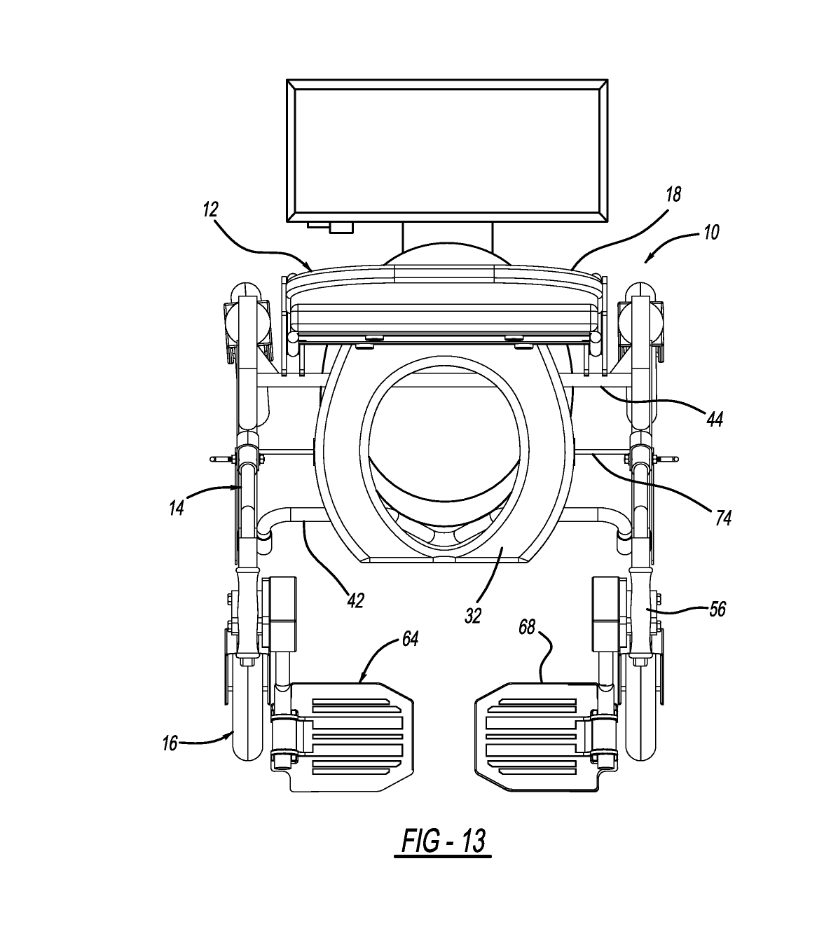

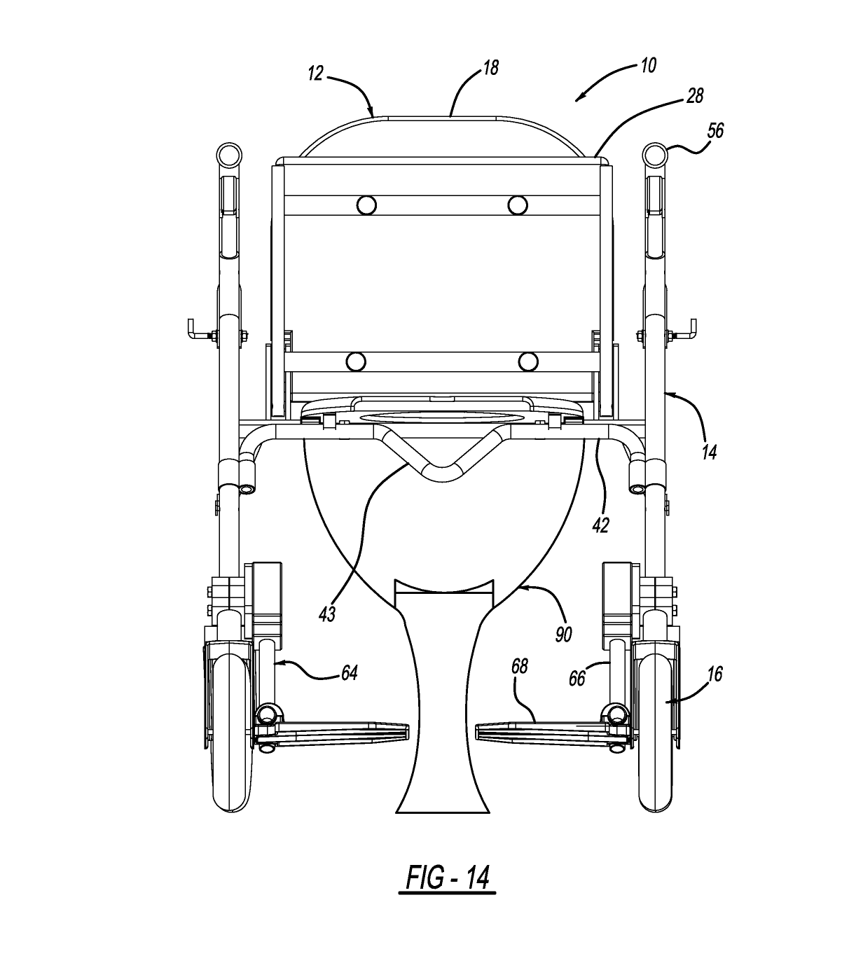

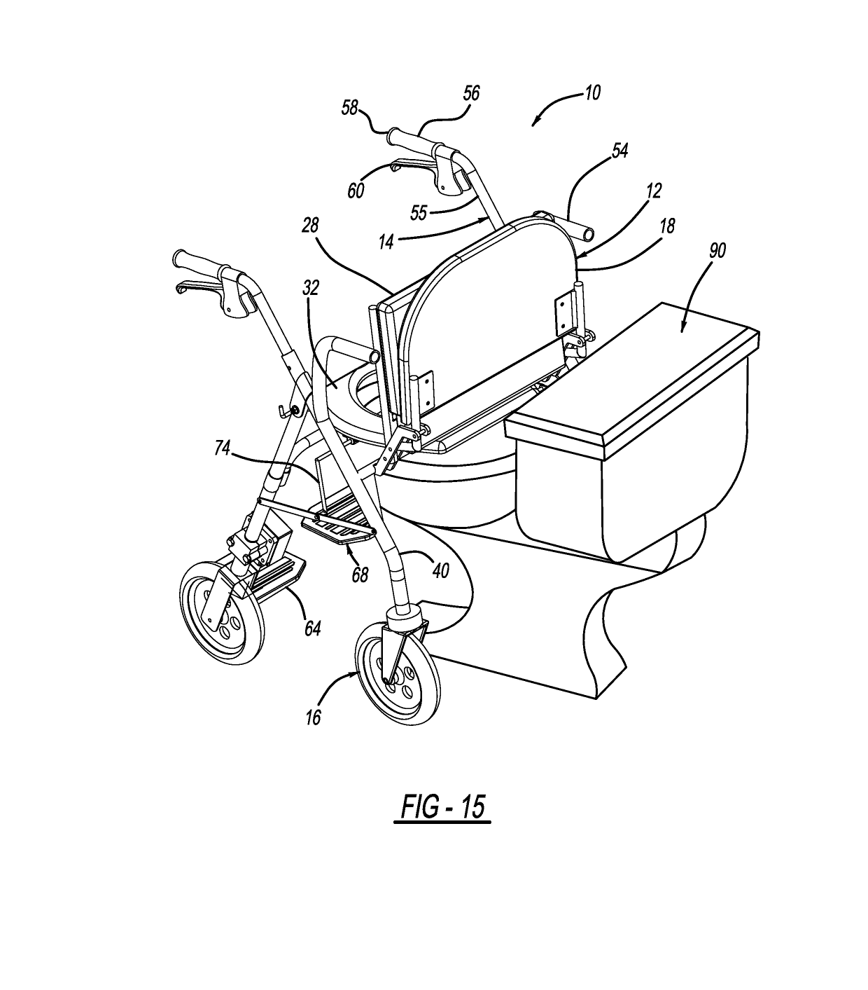

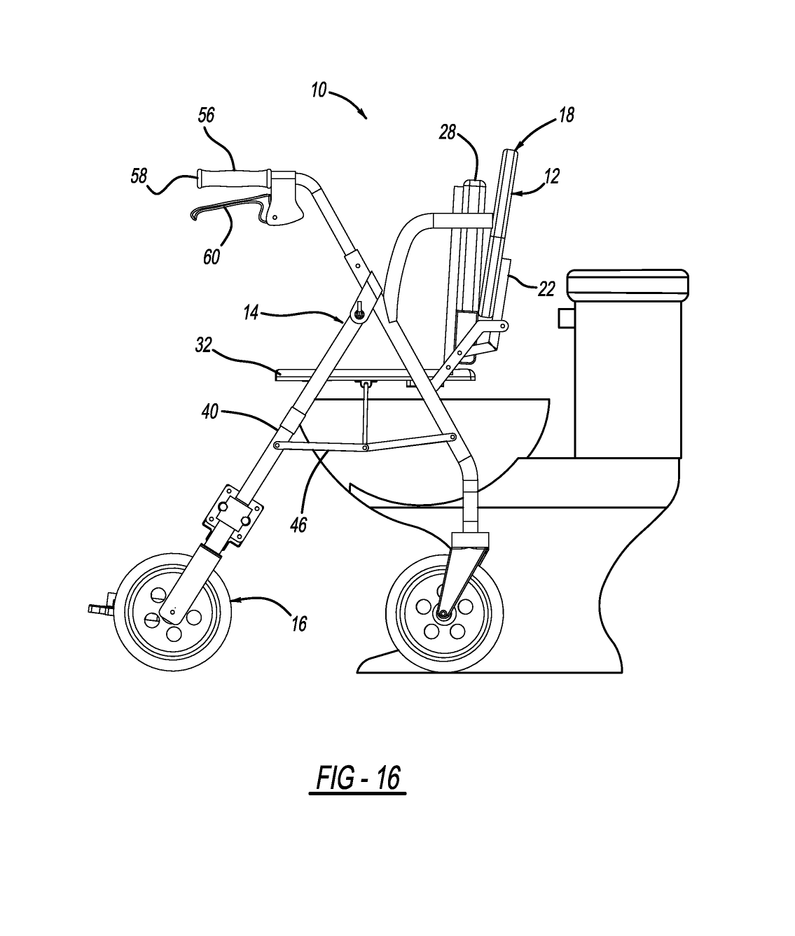

An important feature of walker 10 is its ability to be readily used in a restroom visit by the user. For such use, seat bottom 28 can be pivoted to an upward position as shown in FIGS. 6 and 7 which exposes toilet seat 32. FIGS. 10 through 16 show the device positioned over toilet commode 90. As shown the device is moved over commode 90 with its normal toilet seat (not shown) in an upper position. The device can be moved over the commode 90 until it reaches a final position established by contact with crossbar V bend 43. The height of crossbars 42 and 44 are designed to provide clearance with typical toilet commode designs. Once positioned over toilet commode 90, the user may sit on toilet seat 32 for toilet usage. When finished, seat bottom 28 can be folded back to its normal downward position and the user can back walker 10 out of the bathroom stall for its normal usage.

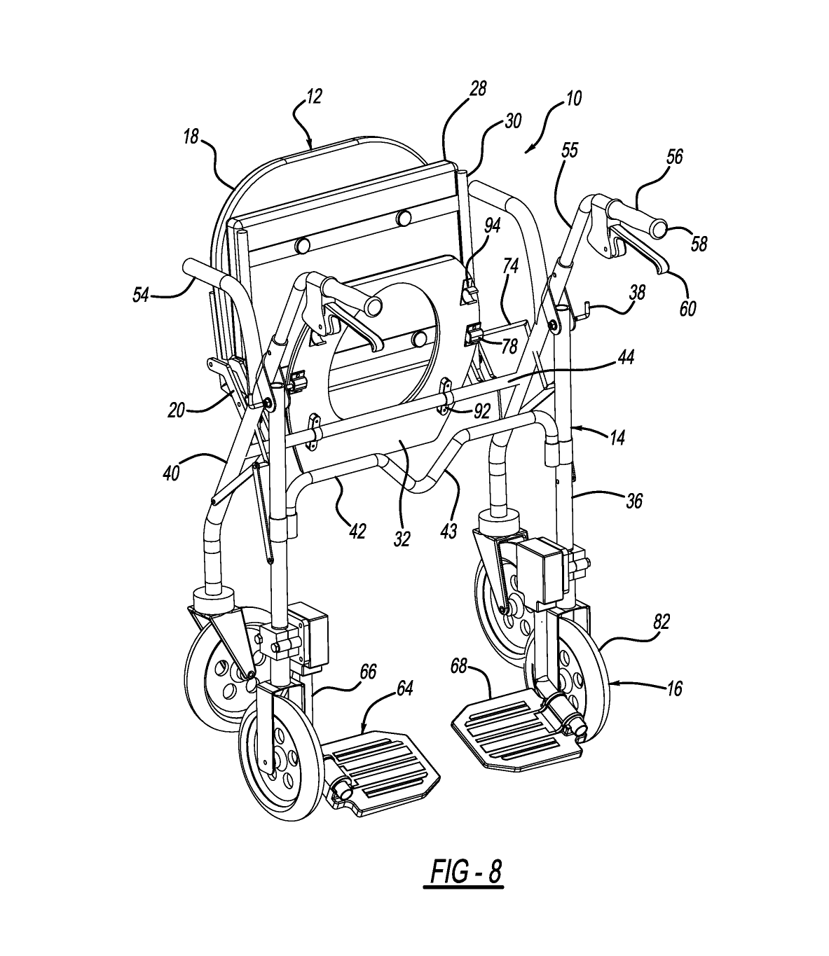

FIG. 8 illustrates the convenient folded-up configuration of walker 10 for storage or transportation. This figure also shows that crossbar 42 has a hinged connection with toilet seat 32 using clamps 92. Snap clamps 94 engage crossbar 42 in the normal usage condition but are released when the device is folded. The articulation of the device from its normal to its folded-up configuration can be conveniently done by lifting the front end of toilet seat 32 to release snap clamps 94. As the toilet seat 32 is rotated to its upper folded position, this action pulls on support link 46 by its connection with the link bars 72 to aid in articulating rear and front legs 36 and 40. Seat back 18 is also foldable and during use it may be folded flat as shown in FIG. 9.

The above description details the numerous degrees of freedom the components have with respect to one another in various facets of the use. These articulating motions and positions of the components allow the device 10 to be operated in various use conditions, including:

Condition #1 illustrated in FIGS. 1 through 5, in which seat back 18 is in a generally vertical condition, and seat bottom 28 is in a horizontal condition overlying toilet seat 32. In this Condition #1, as well as in Conditions #2 and #3 described below, the front and rear legs 36 and 40 are spread apart, separating the front and rear set of wheels 82. Condition #1 enables walker 10 to be used as a chair or aid a standing user.

Condition #2 illustrated by FIG. 9 in which seat back 18 is pivoted forward as it hinges with respect to front legs 40, with seat bottom 28 is in a horizontal condition overlying toilet seat 32. Condition #2 is suited for aiding the user while standing.

Condition #3 illustrated by FIG. 6 in which seat back 18 is in a generally vertical condition and seat bottom 28 is pivoted with respect to front legs 42 to an upward generally vertical condition, exposing toilet seat 32 for use.

Condition #4 illustrated by FIG. 8 in which the front and rear legs 36 and 40 are collapsed together, pushing the front and rear sets of wheels 82 together and also causing seat back 18, seat bottom 28, and toilet seat 32 to all the positioned in a parallel generally vertical condition which corresponds to a folded-up form of walker 10, enabling convenient transportation and storage when not being used.

### RELATED ART

The following references provide background information regarding the technical field in the area of the walker described herein:

US PATENT REFERENCES

| DOCUMENT NUMBER | | |
|---|---|---|
| Number-Kind Code | | |
| (if known) | DATE | NAME |
| 3,038,174 | Jun. 12, 1962 | D. Brown, et al. |
| 3,512,187 | May 19, 1970 | M. I. Thomas, et al. |
| 3,654,643 | Apr. 11, 1972 | Wayne N. Clanan |
| 4,052,087 | Oct. 4, 1977 | Joseph A. Gagliardi |
| 4,067,409 | Jan. 10, 1978 | Paul DiMatteo |
| 4,253,678 | Mar. 3, 1981 | Stanislas Leclerc |
| 5,123,126 | Jun. 23, 1992 | Grover C. Vincent |
| 5,163,188 | Nov. 17, 1992 | Thomas S. Munroe |
| 5,573,261 | Nov. 12, 1996 | S. David Miller |
| 6,176,508 B1 | Jan. 23, 2001 | Pascal Malassigne, et al. |
| 6,338,493 B1 | Jan. 15, 2002 | Eli Wohgemuth, et al. |
| 6,481,730 B2 | Nov. 19, 2002 | Chung-Che Sung |
| 6,547,265 B1 | Apr. 15, 2003 | John Enge |
| 6,837,503 B2 | Jan. 4, 2005 | Kuang-Muh Chen |
| 7,669,863 B2 | Mar. 2, 2010 | Mark Steiner, et al. |
| 2003/0151232 A1 | Aug. 14, 2003 | Tianfu Li |
| 2007/0283990 A1 | Dec. 13, 2007 | Felix L. Fernandez, et al. |
| 2010/0243011 A1 | Sep. 30, 2010 | Li-Hua Lin |
| 2011/0187067 A1 | Aug. 4, 2011 | Gary M. Staggs |
| Des. 356,762 | Mar. 28, 1995 | Jonnie Sibersky |

While the above description constitutes the preferred embodiment of the present invention, it will be appreciated that the invention is susceptible to modification, variation and change without departing from the proper scope and fair meaning of the accompanying claims.

1. A walker for enabling ambulatory movement of a disabled individual comprising;
a frame assembly having at least one rear leg and at least one front leg, the front leg and rear legs having wheel assemblies affixed thereto, the front and the rear legs pivotably connected to one another via at least one hinge, a support linkage connecting the front leg and the rear leg, the support linkage permitting folding together of the front leg and the rear leg in a storage condition of the walker, and permitting the front and the rear leg to be being angularly separated for a use condition of the walker,
a seat assembly including a seat bottom foldable between a generally horizontal down position and a generally vertical up position, a seat back,
a toilet seat affixed to the frame, the seat bottom being pivotable with respect to the frame assembly, the seat bottom overlying the toilet seat when in the down position and exposing the toilet seat for use by the individual when in the up position, and
the frame assembly coupled to the seat assembly and the toilet seat such that the seat assembly and the toilet seat are positioned in a generally parallel orientation when the walker is in the storage condition.

2. A walker in accordance with claim 1 further comprising the frame assembly having a pair of the at least one rear leg and a pair of the at least one front leg, the pairs of the rear legs and the front legs separated and connected together by at least one crossbar, and a pair of the at least one hinge pivotably connecting the pairs of front legs and the pairs of rear legs.

3. A walker in accordance with claim 1 further comprising the support linkage including two link elements which are pivotably connected together and articulate when the walker is moved between the storage and the use conditions.

4. A walker in accordance with claim 2 further comprising the frame assembly including a pair of the crossbars and the toilet seat pivotably connected to a first crossbar of the pair of the crossbars and releasably connected to a second crossbar of the pair of the crossbars.

5. A walker in accordance with claim 4 further comprising a link bar affixed to the support linkage urging the toilet seat to rotate relative to the first crossbar when the walker is moved between the storage and the use conditions.

6. A walker in accordance with claim 1 further comprising the frame assembly having the seat back pivotably attached to the frame assembly such that the seat back can be articulated from a generally vertical back support position to a folded down position overlying the seat bottom and the toilet seat.

7. A walker in accordance with claim 5 further comprising the link bar connected with the support link and pivotably affixed to the toilet seat wherein upward lifting of the toilet seat actuates the support link to move the walker toward the storage condition.

8. A walker in accordance with claim 2 further comprising a first set of handles connected with the front legs for guiding the walker.

9. A walker in accordance with claim 2 further comprising a second set of handles connected with the rear legs for guiding the walker.

10. A walker in accordance with claim 2 further comprising the front legs having foot platforms for the individual's feet when the individual is a seated on the walker seat bottom.

11. A walker in accordance with claim 2 further comprising the frame assembly, the legs, the seat back, the seat bottom and the toilet seat articulating such that the walker can be placed in any one of three forms of the use condition including a first use condition in which seat back is in a generally vertical condition, and the seat bottom is in the down position, a second use condition in which the seat back is pivoted forward as it hinges with respect to the front legs, with the seat bottom in the down position, and a third use condition in which the seat back is in a generally vertical condition and the seat bottom is pivoted with respect to the front legs to the up position.

12. A walker for enabling ambulatory movement of a disabled individual comprising;
a frame assembly having a pair of rear legs and a pair of front legs, the front legs and the rear legs having wheel assemblies affixed thereto, the front and the rear legs pivotably connected to one another via at least one hinge, a first and a second crossbar connecting the front and the rear legs together, a support linkage connecting the front legs and the rear legs, the support linkage articulating to permit folding together of the front legs and the rear legs in a storage condition of the walker and the front and the rear legs being angularly separated for a use condition of the walker,
a seat assembly including a seat bottom foldable between a generally horizontal down position and a generally vertical up position, and a seat back,
a toilet seat affixed to the frame crossbars, the seat bottom being pivotable with respect to the frame assembly, the seat bottom overlying the toilet seat when in the down position and exposing the toilet seat for use by the individual when in the up position and the toilet seat pivotably connected to the first crossbar and releasably connected to the second crossbar, and
the frame assembly coupled to the seat assembly, the seat back, and the toilet seat such that the seat assembly, the seat back, and the toilet seat are positioned in a generally parallel orientation when the walker is in the storage condition.

13. A walker in accordance with claim 12 further comprising a link bar affixed to the support linkage urging the toilet seat to rotate relative to the first crossbar when the walker is moved between the storage and the use conditions.

14. A walker in accordance with claim 12 further comprising the seat back also pivotably attached to the frame assembly such that the seat back can be articulated from a generally vertical back support position to a down position overlying the seat bottom and the toilet seat.

15. A walker in accordance with claim 12 further comprising the link bar connected with the support link and pivotably affixed to the toilet seat wherein upward lifting of the toilet seat actuates the support link to move toward the storage condition of the walker.

16. A walker in accordance with claim 12 further comprising a first set of handles connected with the front legs for guiding the walker.

17. A walker device in accordance with claim 12 further comprising a second set of handles connected with the rear legs for guiding the walker.

18. A walker in accordance with claim 12 further comprising the front legs having foot platforms for the individual's feet when the individual is a seated on the walker.

19. A walker in accordance with claim 12 further comprising the frame assembly, the legs, the seat back, the seat bottom and the toilet seat articulating such that the walker can be placed in any one of three forms of the use condition including a first use condition in which seat back is in a generally vertical condition, and the seat bottom is in the down position, a second use condition in which the seat back is pivoted forward as it hinges with respect to the front legs, with the seat bottom in the down position, and a third use condition in which the seat back is in a generally vertical condition and the seat bottom is pivoted with respect to the front legs to the up position.
